(19) United States
(12) Patent Application Publication
(10) Pub. No.: US 2011/0227831 A1
(43) Pub. Date: Sep. 22, 2011

(54) Determining Properties of Fingers via Keystroke Dynamics

(76) Inventors: Andrew Jesse Mills, Silver Spring, MD (US); Alan Gilbert, Austin, TX (US)

(21) Appl. No.: 13/052,106

(22) Filed: Mar. 20, 2011

Related U.S. Application Data
(60) Provisional application No. 61/315,950, filed on Mar. 21, 2010.

(51) Int. Cl. G06F 3/02

(52) U.S. Cl. 345/168

(57) ABSTRACT

Keystroke dynamics has been widely studied to authenticate and verify computer users, but never has keystroke dynamics been used to directly determine properties of the fingers of the typist. This is a significant limitation because, for example, some of the personal traits correlated with finger ratios—for example, the second to fourth digit ratio predicts success among high frequency traders—cannot be obtained easily from internet users any other way. Users either may not wish to provide this information; the accuracy of the information obtained by asking them directly would be dubious; and/or it might not appear proper for the entity seeking the information to ask for it. The present invention overcomes this by using the timing information of keystroke dynamics to directly determine properties of fingers.

### CROSS-REFERENCE TO RELATED APPLICATIONS

This patent application claims the benefit of the filing date from Provisional Patent #61/315,950, entitled “Measuring Properties of Fingers via Keystroke Dynamics.”

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

1. Field of Invention

The present invention relates to a method of determining properties of users' fingers directly from the timing and pressure data obtained from a user's use of a keyboard.

2. Prior Art

Conventional keystroke dynamics implementations are used exclusively to verify the identity of a user for various purposes by recording and analyzing the way that each user uniquely types. Originally, this technology was implemented only while a user types his or her login information in order to grant access to the appropriate user. This is accomplished in U.S. Pat. No. 4,805,222 to Young et al. (1989) by a user repeatedly typing a passphrase wherein the user trains the computer system to learn and recognize their unique typing pattern such that any unauthorized users' attempted login would be rejected. Improvements upon this system are shown in U.S. Pat. No. 7,509,686 to Checco (2009) and in the research paper “Keystroke Dynamics Based Authentication” published by Obaidat and Sadoun. These particular implementations are effective for security sensitive institutions such as online banking and security trading companies.

The technological implementation of keystroke dynamics has evolved to what Gunetti and Picardi at The University of Torino have termed “free text” keystroke dynamics in their paper, “Keystroke Analysis of Free Text”. This implementation is effective at identifying the user of a computer with public or multiple user access without requiring a user to repeatedly type a specific phrase or login and password. As stated in U.S. Pat. No. 7,260,837 to Abraham et al. (2007), marketing companies can use this technology to display relevant ads within a browser on a family computer by identifying which family member is using the computer at any given time.

All prior art suffers from the disadvantage that it uses keystroke dynamics to identify a person rather than to directly determine properties of the fingers of the typist. This is a significant limitation because some of the personal traits correlated with the properties of fingers—for example, the second to fourth digit ratio predicts success among high frequency traders (see “Second-to-fourth digit ratio predicts success among high-frequency financial traders” by Coates et al.)—cannot be obtained easily from Internet users any other way. Users either may not wish to provide this information; the accuracy of the information obtained by asking them directly would be dubious; and/or it might not appear proper for the entity seeking the information to ask for it. See “http://en.wikipedia.org/wiki/Digit_ratio” for an extensive list of personal traits believed to be correlated to a person's digit ratios. The term “personality trait” is meant in this patent as a “quality or characteristic of a person.” This definition was very slightly modified from “http://wilderdom.com/personality/traits/PersonalityTraitsDefinitions.html”.

Additionally, there is no known way to automatically determine if a user on a remote computer has an injured finger. This is useful, for example, in determining whether to increase tolerances for verification systems based on keystroke dynamics. A user with an injured finger is likely to type less consistently.

### OBJECTS AND ADVANTAGES

Accordingly, the advantage of our invention is that it uses keystroke dynamics to directly determine properties of fingers of a typist.

### BRIEF SUMMARY OF THE INVENTION

The present invention records each keystroke's timing and/or pressure information, grouped by which finger is believed to have made that keystroke. One embodiment uses this data to determine the ratios of the lengths of fingers. Another embodiment uses this data to detect injured fingers.

### DRAWINGS

Not Applicable

### DETAILED DESCRIPTION OF THE INVENTION

Keyboards generally are not specifically tailored to each person's specific hands. On a high level, the crux of the present invention is that different hands using the same or similar keyboards will necessarily produce different outcomes.

We first recall the terminology of a “dwell” and a “transition” among literature in keystroke dynamics. A dwell is a user holding down one key. A dwell is associated the length of time the typist held that key down for. A transition is the movement from one key to the next key. So a transition is associated with two keys (these keys may be the same). It is also associated with the time it took the typist to switch which key they were pushing. This time is commonly measured in several different ways. Without limitation, two ways are the difference in time between when the second key started being pushed and the first key started being pushed, and the difference in time between when the second key started being pushed and the first key stopped being pushed.

The method of the first embodiment of our invention proceeds as follows. First, choose two fingers to study—call them finger 1 and finger 2. Next, take a group of people whose ratios of lengths of finger 1 to finger 2 we know. Then, have these people use a keyboard for a suitable amount. Record their keystrokes and the timing of these keystrokes they type. Extract how long it takes each user's finger 1 to transition from keys closer to them to keys further from them, and the opposite. For example, if finger 1 is the left ring finger, the keyboard layout was standard QWERTY, and we believed the user typed the way typing classes teach, then extract the transition times among the “w”, “s”, and “x” keys. We extract this data for finger 2 as well. Then, determine a mathematical correlation between the known finger ratios and the extracted transition times. One example mathematical correlation is a multiple linear regression, but the present invention covers any mathematical correlation. Then, a user with an unknown finger length ratio types on keyboard. This keyboard need not be the same device or even the same model of device that the users in the training test used. This is because user's fingers settle into highly ingrained patterns over time that are largely insensitive of which keyboard they use. For example, the user's typing information could be recorded over the Internet. The transition times for finger 1 and finger 2 of this user are extracted. The results of the mathematical correlation are applied to this extracted data, and a finger length ratio for the user is approximated.

Let us take a moment to explain why this invention works. The “home row” of a keyboard is defined as the keys users generally rest their fingers on when they pause between typing. The home row need not be straight row, depending on the keyboard. However, a finger that is longer than the others on a hand will more naturally extend by the length of one key than flex by the length of one key. Note that this is insensitive to the average lengths of the fingers—what matters is length of one finger compared to the lengths of the other fingers on that hand. Therefore, if finger 1 is the left ring finger, and we believe the user types “w”, “s”, and “x” with that finger, a longer than usual finger 1 compared to the rest of the hand will transition from “s” to “w” faster than other people but transition from “s” to “x” slower.

The method described is the most accurate; however a user might not type many transitions between, for instance “w”, “s”, and “x”. Therefore, another embodiment which potentially requires less typing from a user is to consider transitions that may start on any key but end on fingers 1 or 2. Oftentimes, a user will not move a finger to type a key until the previous key has been pushed. This means a transition from a key not pushed by finger 1 to a key pushed by finger 1 will require finger 1 to move from its natural resting spot on the home row to wherever the key is. And, as said before, this time is correlated with the relative length of finger 1 compared to the rest of the hand (depending on whether the key is closer or further away from the user).

This invention naturally also covers extensions to correlating the dwell times and pressure patterns of keystrokes to finger ratios. For example, if a user has an unusually long finger compared to her hand, that finger will naturally press down on keys harder than that corresponding finger of other people, as that finger will find it more comfortable to extend from being in a more tightly flexed state than the other fingers.

The second embodiment of the present invention is similar in spirit, although has a few different details. First, record the keystrokes, the timing of keystrokes, and the pressure of keystrokes a user types on a keyboard. Choose a finger to study—call it finger 1. An injured finger will have a higher variance of motion in typing. It will also strike the keyboard with less force. Therefore, when the variance of typing is too high (particularly the transition times, which involve movement) or the pressure a key is pressed is too low, the invention will report that there is a high likelihood of a finger being injured.

### Conclusions, Ramifications, and Scope

Keystroke dynamics has already shown to be powerful in that it can identify users by the way they type on a keyboard. But its power is even broader in that it can also identify properties of the fingers of the typist. These broader powers even hold when our invention is applied to, for example, non-QWERTY keyboard layouts, keypads, touch-screens, mobile phone keyboards, etc.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

We claim:

1. A method of approximating finger length ratios of users' hands while they type on a keyboard, comprising:
a. recording keystrokes and the timing of keystrokes a plurality of users type on a keyboard;
b. selecting two fingers to study, hereafter referred to as fingers 1 and 2;
c. determining which keystrokes recorded in part a were likely typed by fingers 1 and 2 respectively of each user's respective hands;
d. extracting from part a the times it takes each user to transition to keys typed by said user's finger 1, with help from part c;
e. extracting from part a the times it takes each user to transition to keys typed by said user's finger 2, with help from part c;
f. approximating the ratio of the lengths of fingers 1 and 2 for each of the plurality of users;
g. determining a mathematical correlation between the data of parts d and e and the data of part f;
h. recording keystrokes and the timing of keystrokes a later user types on a keyboard;
i. determining which keystrokes recorded in part h were likely typed by said later user's fingers 1 and 2 respectively;
j. extracting from part h the times it takes said later user to transition to keys typed by said later user's finger 1, with help from part i;
k. extracting from part h the times it takes said later user to transition to keys typed by said later user's finger 2, with help from part i; and
l. applying the results of said mathematical correlation on the data of parts j and k;
whereby the result of part 1 approximates the ratio of the lengths of said later user's fingers 1 and 2.

2. The method of 1 further including: the data collection in part a also including measuring other properties of said users, the mathematical correlation in part g also including analysis of said other properties, the data collection in part h also including measuring said other properties of said later user, and the final calculation in part 1 also utilizing said other properties of said later user.

3. The method of 1 wherein the extraction of part d only considers those transitions starting with said user's finger 1, the extraction of part e only considers those transitions starting with said user's finger 2, the extraction of part j only considers those transitions starting with said later user's finger 1, and the extraction of part k only considers those transitions starting with said later user's finger 2.

4. The method of 1 further including using the finger length ratio found in part 1 to determine a personality trait of said later user.

5. The method of 2 further including using the finger length ratio found in part 1 to determine a personality trait of said later user.

6. The method of 3 further including using the finger length ratio found in part 1 to determine a personality trait of said later user.

7. A method of detecting a longer than usual finger of a user's hand while he/she types on a keyboard, comprising:
a. recording keystrokes and the timing of keystrokes a plurality of users type on a keyboard;
b. determining which keystrokes recorded in part a were likely typed by a specific finger of each user's respective hands;
c. extracting from part a the times it takes each user to transition to keys typed by said user's said specific finger, with help from part b;
d. approximating the ratios of the length of said specific finger to the lengths of said user's other fingers for each of the plurality of users;
e. determining a mathematical correlation between the data of part c and the data of part d;
f. recording keystrokes and the timing of keystrokes a later user types on a keyboard;
g. determining which keystrokes recorded in part f were likely typed by said later user's said specific finger;
h. extracting from part f the times it takes said later user to transition to keys typed by said later user's said specific finger, with help from part g; and
i. applying the results of said mathematical correlation on the data of part h, whereby the result of part i approximates the ratio of the length of said later user's said specific finger to the lengths of said later user's other fingers.

8. The method of 7 further including: the data collection in part a also including measuring other properties of said users, the mathematical correlation in part e also including analysis of said other properties, the data collection in part f also including measuring said other properties of said later user, and the final calculation in part i also utilizing said other properties of said later user.

9. The method of 7 wherein the extraction of part c only considers those transitions starting with said user's said specific finger and the extraction of part h only considers those transitions starting with said later user's said specific finger.

10. A method of approximating finger length ratios of users' hands while they type on a keyboard, comprising:
a. recording keystrokes and the timing of keystrokes a plurality of users type on a keyboard;
b. selecting two fingers to study, hereafter referred to as fingers 1 and 2;
c. determining which keystrokes recorded in part a were likely typed by fingers 1 and 2 of each user's respective hands;
d. extracting from part a the lengths of time each user holds down keys typed by said user's finger 1, with help from part c;
e. extracting from part a the lengths of time each user holds down keys typed by said user's finger 2, with help from part c;
f. approximating the ratio of the lengths of fingers 1 and 2 for each of the plurality of users;
g. determining a mathematical correlation between the data of parts d and e and the data of part f;
h. recording keystrokes and the timing of keystrokes a later user types on a keyboard;
i. determining which keystrokes recorded in part h were likely typed by said later user's finger 1 and 2;
j. extracting from part h the lengths of time said later user holds down keys typed by said later user's finger 1, with help from part i;
k. extracting from part h the lengths of time said later user holds down keys typed by said later user's finger 2, with help from part i; and
l. applying the results of said mathematical correlation on the data of parts j and k;
whereby the result of part 1 approximates the ratio of the lengths of said later user's fingers 1 and 2.

11. The method of 10 further including: the data collection in parts a and h also including measuring other properties of said plurality of users, the mathematical correlation in part g also including analysis of said other properties, and the final calculation in part 1 also utilizing said other properties of said later user.

12. A method of approximating finger length ratios of users' hands while they type on a keyboard, comprising:
a. recording keystrokes and the pressure of keystrokes a plurality of users type on a keyboard;
b. selecting two fingers to study, hereafter referred to as fingers 1 and 2;
c. determining which keystrokes recorded in part a were likely typed by fingers 1 and 2 of each user's respective hands;
d. extracting from part a the pressure patterns each user makes on keys typed by said user's finger 1, with help from part c;
e. extracting from part a the pressure patterns each user makes on keys typed by said user's finger 2, with help from part c;
f. approximating the ratios of the lengths of fingers 1 and 2 for each of the plurality of users;
g. determining a mathematical correlation between the data of parts d and e and the data of part f;
h. recording keystrokes and the pressure of keystrokes a later user types on a keyboard;
i. determining which keystrokes recorded in part h were likely typed by said later user's finger 1 and 2;
j. extracting from part h the pressure patterns said later user makes on keys typed by said user's finger 1, with help from part i;
k. extracting from part h the pressure patterns said later user makes on keys typed by said user's finger 2, with help from part i; and
1. applying the results of said mathematical correlation on the data of parts j and k;
whereby the result of part 1 approximates the ratio of the lengths of said later user's fingers 1 and 2.

13. The method of 12 further including: the data collection in parts a and h also including measuring other properties of said plurality of users, the mathematical correlation in part g also including analysis of said other properties, and the final calculation in part 1 also utilizing said other properties of said later user.

14. The method of 10 further including using the finger length ratio found in part 1 to determine a personality trait of said later user.

15. The method of 11 further including using the finger length ratio found in part 1 to determine a personality trait of said later user.

16. The method of 12 further including using the finger length ratio found in part 1 to determine a personality trait of said later user.

17. The method of 13 further including using the finger length ratio found in part 1 to determine a personality trait of said later user.

18. A method of determining if a user's finger is injured while the user types on a keyboard, comprising:
a. recording keystrokes and the pressure of keystrokes said user types on said keyboard;
b. determining which keystrokes recorded in part a were likely typed by said user's finger; and
c. if the pressure of the keystrokes determined in part b is below a threshold; outputting that said user's finger is likely injured.

19. The method of 18 further including setting said threshold by examining the pressures of prior keystrokes.

20. The method of 19 wherein said prior keystrokes include said user's prior keystrokes.

21. A method of determining if a user's finger is injured while the user types on a keyboard, comprising:
a. recording keystrokes and the timing of keystrokes said user types on said keyboard;
b. determining which keystrokes recorded in part a were likely typed by said user's finger;
c. extracting from part a the times it takes said user to transition to keys typed by said user's finger, with help from part b; and
d. if the variance of the transition times in part c is above a threshold, outputting that said user's finger is likely injured.

22. The method of 21 further including setting said threshold by examining the transition times of prior keystrokes.

23. The method of 22 wherein said prior keystrokes include said user's prior keystrokes.

24. The method of 21 wherein the extraction of part c only considers those transitions starting with said user's finger.

25. The method of 24 further including setting said threshold by examining the transition times of prior keystrokes.

26. The method of 25 wherein said prior keystrokes include said user's prior keystrokes.
